(19) United States
(12) Patent Application Publication
(10) Pub. No.: US 2012/0120129 A1
(43) Pub. Date: May 17, 2012

(54) DISPLAY CONTROLLER DRIVER AND METHOD FOR TESTING THE SAME

(75) Inventor: Hsing-Chien Yang, Hsinchu County (TW)

(73) Assignee: NOVATEK MICROELECTRONICS CORP., Hsinchu (TW)

(21) Appl. No.: 13/208,355

(22) Filed: Aug. 12, 2011

Related U.S. Application Data
(60) Provisional application No. 61/412,395, filed on Nov. 11, 2010.

(30) Foreign Application Priority Data
Apr. 28, 2011 (TW) 100114932

(51) Int. Cl. G09G 5/10

(52) U.S. Cl. 345/691

(57) ABSTRACT

A display controller driver and a testing method therewith are provided. The display controller driver includes a timing control circuit, an image data memory, a data line driving circuit and a scan line driving circuit. The testing method includes controlling the scan line driving circuit by a control signal in a test operation mode, wherein the control signal is generated by an external test platform. The scan line driving circuit is tested and measured in accordance with a test pattern of the control signal.

### CROSS-REFERENCE TO RELATED APPLICATION

This application claims the priority benefits of U.S. provisional application Ser. No. 61/412,395, filed on Nov. 11, 2010 and Taiwan application serial no. 100114932, filed on Apr. 28, 2011. The entirety of each of the above-mentioned patent applications is hereby incorporated by reference herein and made a part of this specification.

### BACKGROUND OF THE INVENTION

1. Field of the Invention

The invention relates to a display controller driver and a method for testing the same. Particularly, the invention relates to a display controller driver capable of receiving an external control signal for testing, and a method for testing the same.

2. Description of Related Art

FIG. 1 is a block schematic diagram of a conventional display controller driver 120 of a display panel 140. The display controller driver 120 includes a system interface circuit 122, a memory control circuit 124, an image data memory 126, a timing control circuit 128, a latch circuit 130, a data line driving circuit 132, a scan line driving circuit 134 and a grayscale voltage generating circuit 136. The system interface circuit 122 is coupled to an external processor 110, and the data line driving circuit 132 and the scan line driving circuit 134 are coupled to the display panel 140.

When the display controller driver 120 is operated in a normal operation mode, the external processor 110 transmits display data to the memory control circuit 124 through the system interface circuit 122. The memory control circuit 124 temporarily stores the display data in the image data memory 126. The timing control circuit 128 sends control signals to the memory control circuit 124, the latch circuit 130, the data line driving circuit 132, the scan line driving circuit 134 and the grayscale voltage generating circuit 136 in timing. For example, the timing control circuit 128 the reads image data from the image data memory 126 through the memory control circuit 124, and transmits the image data to the latch circuit 130. The latch circuit 130 latches the image data according to a latch pulse of the timing control circuit 128 and transmits it to the data line driving circuit 132. The timing control circuit 128 further controls the data line driving circuit 132 and the scan line driving circuit 134 for transmitting the image data to pixels in the display panel 140, so as to display a corresponding image.

FIG. 2 is a timing diagram of the display controller driver 120 of FIG. 1 in the normal operation mode. Here, it is assumed that the scan line driving circuit 134 includes a plurality of output terminals. For example, a first output terminal G1 of the scan line driving circuit 134 drives a first scan line of the display panel 140, a second output terminal G2 drives a second scan line of the display panel 140, a third output terminal G3 drives a third scan line of the display panel 140, and an N^{th} output terminal GN drives an N^{th} scan line of the display panel 140. A gate address varied every a predetermined time is transmitted from the timing control circuit 128. The scan line driving circuit 134 sequentially drives the scan lines of the display panel 140 through the output terminals G1-GN according to the gate addresses. As shown in an upper part of FIG. 2, a fixed time, i.e. a frame time is divided into N gate driving periods T. Under control of the timing control circuit 128, the scan line driving circuit 134 sequentially drives one of the scan lines of the display panel 140 at different gate driving periods T.

A lower part of FIG. 2 includes (1) display data of a data line driver in the data line driving circuit 132; (2) a latch pulse transmitted from the timing control circuit 128 that is used to control the latch circuit 130; (3) a gate address transmitted from the timing control circuit 128 that is varied every a predetermined time; (4) a gate enable signals XDOFF transmitted from the timing control circuit 128 that is varied every a predeteimined time; and (5) a control signal XDONB transmitted from the timing control circuit 128. The control signal XDONB has the highest priority. When the control signal XDONB has a logic low level L, all outputs of the scan line driving circuit 134 have a high level voltage VGH. Under the normal operation mode, the control signal XDONB is maintained to a logic high level H. When the gate enable signal XDOFF has the logic low level, the scan line driving circuit 134 outputs the high level voltage VGH to one of the output terminals G1-GN according to the gate address provided by the timing control circuit 128, and the other output terminals output a low level voltage VGL, as that shown in FIG. 2. When the gate enable signal XDOFF has the logic high level, all outputs of the scan line driving circuit 134 are the low level voltage VGH. A level of the voltage VGH is higher than a level of the voltage VGL.

When a test operation is performed on the display controller driver 120, the display controller driver 120 is operated in a test operation mode, and the external processor 110 writes a test pattern into the image data memory 126 in advance through the system interface circuit 122 and the memory control circuit 124. After the test pattern is written into the image data memory 126, the timing control circuit 128 reads the test pattern from the image data memory 126 through the memory control circuit 124 in timing, and transmits the test pattern to the data line driving circuit 132 through the latch circuit 130. The timing control circuit 128 generates a corresponding control signal according to the test pattern to control the data line driving circuit 132 and the scan line driving circuit 134, and outputs the test patterns through the data line driving circuit 132 and the scan line driving circuit 134. An external test equipment is used to measure the outputs of the data line driving circuit 132 and the outputs the scan line driving circuit to determine whether the display controller driver 120 passes the test.

The test of the scan line driving circuit 134 includes three behaviours modes: (1) making all of the output terminals G1-GN of the scan line driving circuit 134 to output the low level voltage VGL, as that shown in FIG. 3A; (2) making all of the output terminals G1-GN of the scan line driving circuit 134 to output the high level voltage VGH, as that shown in FIG. 3A; and (3) making one of the output terminals G1-GN of the scan line driving circuit 134 to output the high level voltage VGH, and the other output terminals to output the low level voltage VGL, as that shown in FIG. 3B.

The test of the scan line driving circuit 134 is performed according to a fixed time for one frame and the number N of the output terminals of the scan line driving circuit 134. The fixed time for one frame is divided according to the number of the output terminals of the scan line driving circuit 134, and the test is sequentially performed in allusion to each output terminal of the scan line driving circuit 134 within each divided time section (for example, a gate driving period T). The test performed on the scan line driving circuit 134 may include determining whether a driving voltage is enough, etc. The time section T of FIG. 2 is obtained by dividing each frame time into N time sections (N time sections T). Regarding a display driver IC (i.e. the display controller driver 120), the driving voltage has to be sequentially output from the output terminals G1-GN in alternation, and when each of the output terminals G1-GN is tested, a testing result thereof has to be waited, which prolongs a test time.

An amelioration method is provided based on the conventional test structure, in which an oscillator is used to speed an operating frequency to shorten the test time. However, such method may probably cause a so-called false error message to influence a test result due to that a design structure of the scan line driving circuit 134 cannot match the speeded operating frequency.

### SUMMARY OF THE INVENTION

The invention provides a display controller driver adapted to drive a display panel. The display controller driver includes a timing control circuit, an image data memory, a data line driving circuit and a scan line driving circuit. The image data memory stores display data. The data line driving circuit receives the display data and outputs a grayscale voltage signal corresponding to the display data. The scan line driving circuit is controlled by a first control signal generated by the timing control circuit in a normal operation mode, and is controlled by a second control signal generated by an external test platform in a test operation mode, where the second control signal serves as a test pattern for testing the display controller driver.

In an embodiment of the invention, the scan line driving circuit performs test according to the test pattern, which includes sequentially triggering a plurality of output stage circuits in internal of the scan line driving circuit; making all of the output stage circuits to simultaneously output a first level voltage; and making all of the output stage circuits to simultaneously output a second level voltage, where the first level is higher than the second level.

The invention provides a method for testing a display controller driver, where the display controller driver is adapted to drive a display panel, and the display controller driver includes a timing control circuit, an image data memory, a data line driving circuit and a scan line driving circuit. The method includes controlling the scan line driving circuit by a control signal in a test operation mode, wherein the control signal is generated by an external test platform. The scan line driving circuit is tested and measured according to a test pattern of the control signal.

In an embodiment of the invention, the step that the scan line driving circuit performs test according to the test pattern includes sequentially triggering a plurality of output stage circuits in internal of the scan line driving circuit; making all of the output stage circuits to simultaneously output a first level voltage; and making all of the output stage circuits to simultaneously output a second level voltage, where the first level is higher than the second level.

In an embodiment of the invention, the control signal is transmitted to the scan line driving circuit from the external test platform through the timing control circuit.

In an embodiment of the invention, the control signal is directly transmitted to the scan line driving circuit from the external test platform.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram of a conventional display controller driver.

FIG. 2 is a timing diagram of the display controller driver of FIG. 1 in a normal operation mode.

FIG. 3A and FIG. 3B are voltage level schematic diagrams of outputting test signals to a scan line driving circuit.

FIG. 4 is a block schematic diagram of a display controller driver according to an embodiment of the invention.

FIG. 5 is a partial block schematic diagram of a display controller driver according to another embodiment of the invention.

FIG. 6 is a test timing diagram of a scan line driving circuit according to an embodiment of the invention.

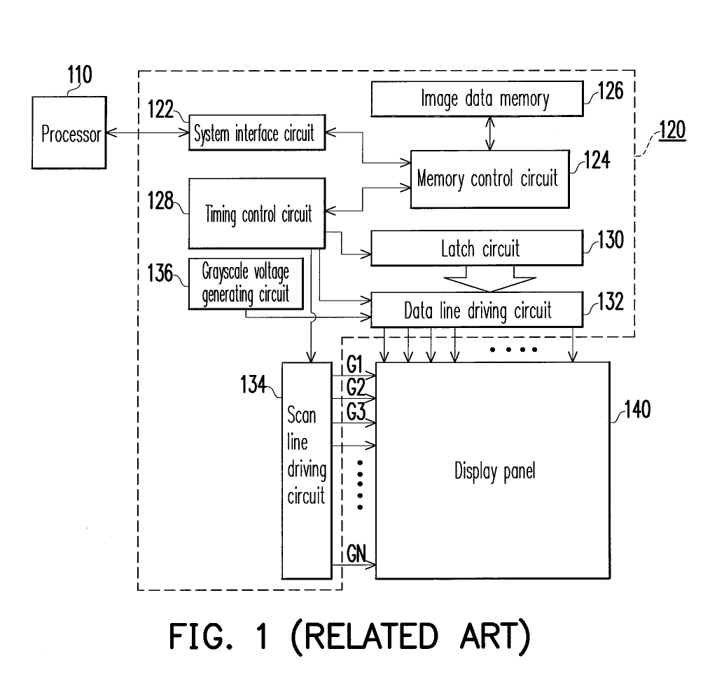

### DETAILED DESCRIPTION OF DISCLOSED EMBODIMENTS

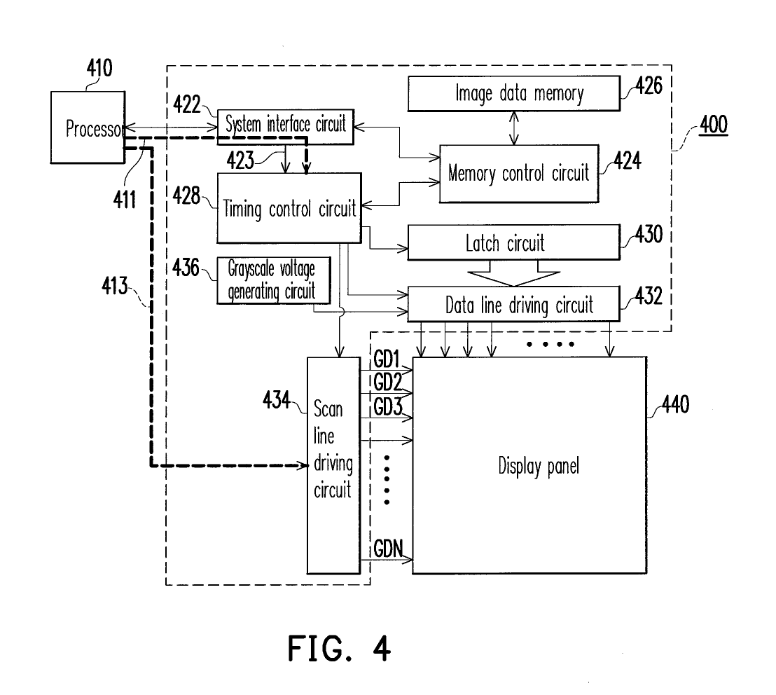

FIG. 4 is a block schematic diagram of a display controller driver according to an embodiment of the invention. The display controller driver 400 includes a system interface circuit 422, a memory control circuit 424, an image data memory 426, a timing control circuit 428, a latch circuit 430, a data line driving circuit 432, a scan line driving circuit 434 and a grayscale voltage generating circuit 436. The system interface circuit 422 is coupled to a processor 410 of an external test platform, and the data line driving circuit 432 and the scan line driving circuit 434 can be coupled to a display panel 440 or a measurement equipment of the external test platform. The processor 410 can be a display device, a handheld electronic device (for example, a mobile phone or a personal digital assistant (PDA)), or internal processing devices of other electronic devices. In another embodiment, the processor 410 can be a processor of a test device.

When the controller driver 400 is operated in a normal operation mode, the external processor 410 transmits image data to the memory control circuit 424 through the system interface circuit 422. The memory control circuit 424 temporarily stores the image data in the image data memory 426. The timing control circuit 428 sends corresponding control signals to the memory control circuit 424, the latch circuit 430, the data line driving circuit 432, the scan line driving circuit 434 and the grayscale voltage generating circuit 436 in timing. For example, the timing control circuit 428 reads image data from the image data memory 426 through the memory control circuit 424, and transmits the image data to the latch circuit 430. The latch circuit 430 latches the image data according to a latch pulse of the timing control circuit 428 and transmits it to the data line driving circuit 432. The timing control circuit 428 further controls the data line driving circuit 432 and the scan line driving circuit 434 for transmitting the image data to pixels in the display panel 440, so as to display a corresponding image.

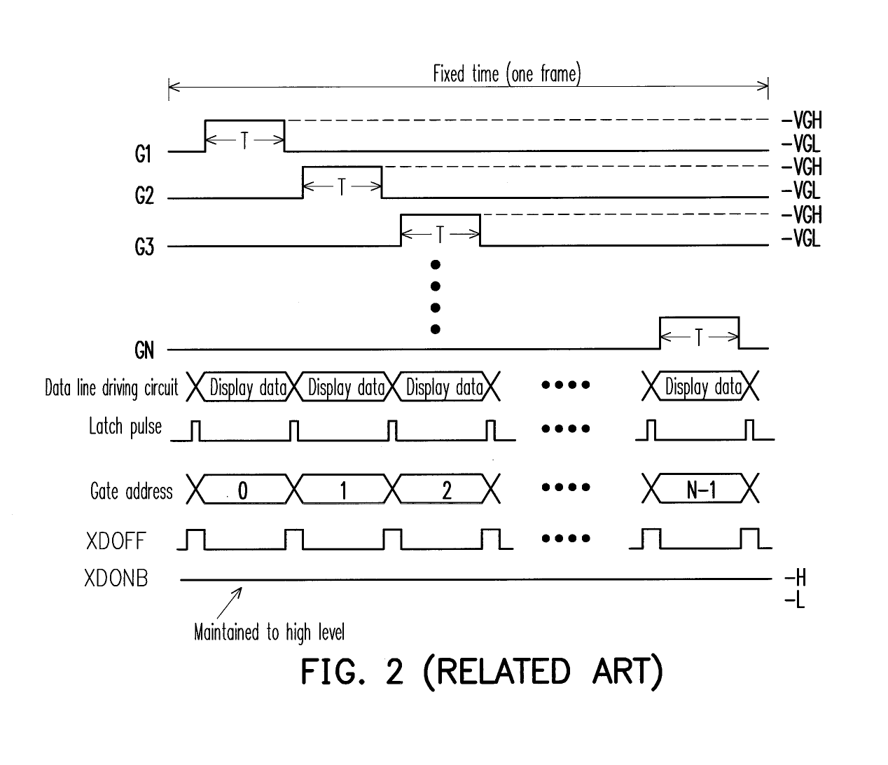

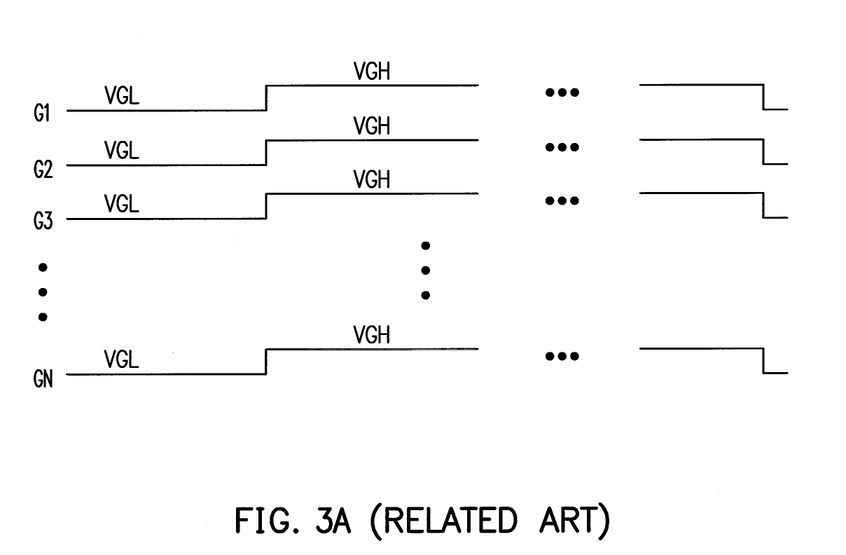

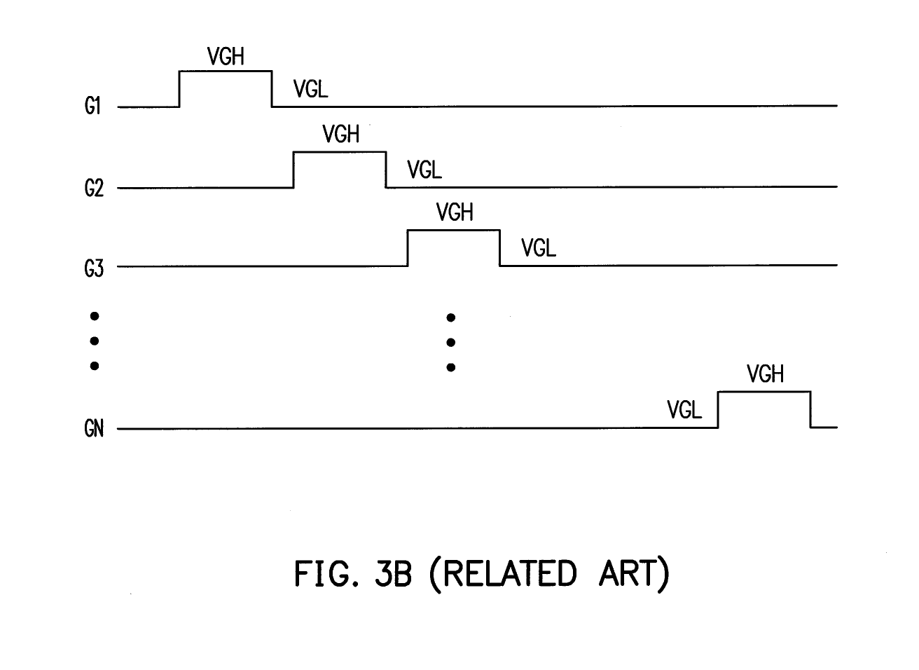

In the normal operation mode, the scan line driving circuit 434 is controlled by a first control signal generated by the timing control circuit 428 to drive a plurality of scan lines of the display panel 440. The control signal generated by the timing control circuit 428 and the outputs of the scan line driving circuit 434 can refer to the related descriptions of FIG. 2. The grayscale voltage generating circuit 436 generates grayscale voltages to the data line driving circuit 432. The data line driving circuit 432 receives the display data and outputs grayscale voltage signals corresponding to the display data to a plurality of data lines of the display panel 440.

When a test operation is performed on the display controller driver 400, the display controller driver 400 is operated in a test operation mode. In the test operation mode, the scan line driving circuit 434 is controlled by a second control signal provided by the external test platform (the processor 410), where the second control signal serves as a test pattern for testing the display controller driver 400. The second control signal includes a gate address, a gate enable signal XDOFF and a control signal XDONB. The control signal (the test pattern) required by the scan line driving circuit 434 is provided by the external test platform.

In an embodiment, the processor 410 can transmit the second control signal to the timing control circuit 428 through a path 411, i.e. through the system interface circuit 422. In the normal operation mode, the timing control circuit 428 selects to transmit the first control signal generated by itself to the scan line driving circuit 434. In the test operation mode, the timing control circuit 428 selects to transmit the second control signal generated by the external test platform (the processor 410) to the scan line driving circuit 434. Therefore, the processor 410 can write commands to the timing control circuit 428 through the system interface circuit 422 to test the scan line driving circuit 434 with the test pattern directly.

In another embodiment, the scan line driving circuit 434 can be directly connected to the system interface circuit 422. Therefore, the processor 410 can directly transmit the second control signal generated by the external test platform (the processor 410) to the scan line driving circuit 434 through the system interface circuit 422. If the processor 410 transmits a control command to the scan line driving circuit 434 through the system interface circuit 422 directly connected to the timing control circuit 428, the second control signal is transmitted after the processor 410 activates the timing control circuit 428.

Moreover, in another electively embodiment, the scan line driving circuit 434 can be directly coupled to the external test platform (the processor 410). The processor 410 can directly transmit the test pattern used for testing the scan line driving circuit 434 to the scan line driving circuit 434 through a direct data transmission path 413.

When the display controller driver 400 is operated in the test operation mode, the scan line driving circuit 434 is controlled by the control signal generated by the external processor 410, and is not controlled by the timing control circuit 428. In the test operation mode, the processor 410 directly transmits the test pattern to the scan line driving circuit 434 for testing. In an embodiment, the scan line driving circuit 434 performs test according to the test pattern, which includes (1) sequentially triggering a plurality of output stage circuits in internal of the scan line driving circuit 434 to make one of the output stage circuits outputting a first level (for example, the high level voltage VGH) and the other output stage circuits outputting a second level (for example, the low level voltage VGL); (2) making all of the output stage circuits to simultaneously output the first level; and (3) making all of the output stage circuits to simultaneously output the second level.

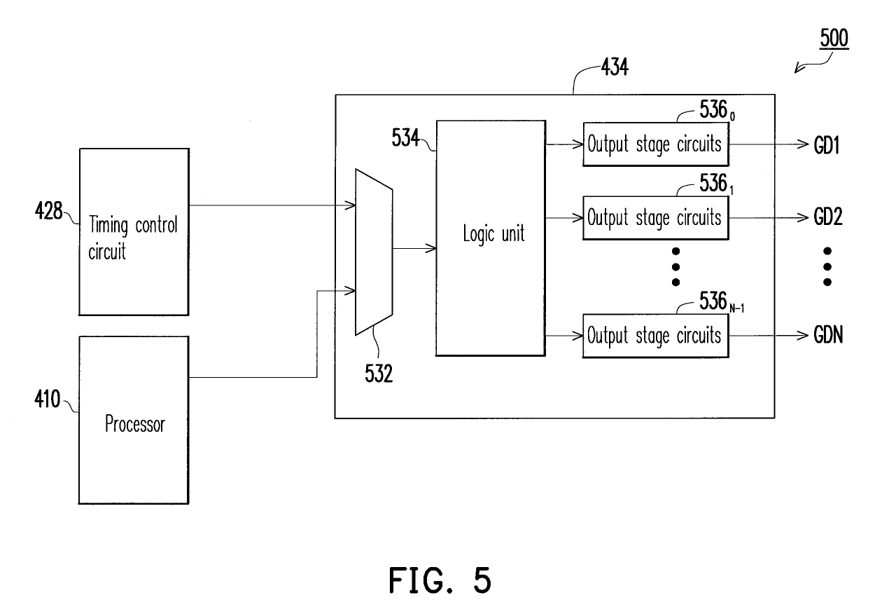

FIG. 5 is a partial block schematic diagram of a display controller driver 500 according to another embodiment of the invention. In the display controller driver 500, the processor 410 of the external test platform can be directly connected to the scan line driving circuit 434, or can be coupled to the scan line driving circuit 434 through the system interface circuit 422, or coupled to the scan line driving circuit 434 through the system interface circuit 422 and the timing control circuit 428. As shown in FIG. 5, the processor 410 and the timing control circuit 428 are respectively connected to the scan line driving circuit 434. The scan line driving circuit 434 includes a selection circuit 532, a logic unit 534, and a plurality of output stage circuits 536₀-536_{N-1}. Output terminals of the output stage circuits 536₀-536_{N-1} serve as output terminals GD1, GD2, GD3, . . . , GDN of the scan line driving circuit 434.

The selection circuit 532 has a first input terminal, a second input terminal and an output terminal. The first input terminal of the selection circuit 532 receives the first control signal generated by the timing control circuit 428. The second input terminal of the selection circuit 532 receives the second control signal generated by the processor 410 of the external test platform. In the normal operation mode, the output terminal of the selection circuit 532 outputs the first control signal generated by the timing control circuit 428 to the logic unit 534. In the test operation mode, the output terminal of the selection circuit 532 outputs the second control signal generated by the processor 410 to the logic unit 534. The selection circuit 532 switches to obtain gate control signals from the processor 410 or the timing control circuit 428.

The logic unit 534 is coupled between the output terminal of the selection circuit 532 and the output stage circuits 536₀-536_{N-1}. The logic unit 534 selectively triggers the output stage circuits 536₀-536_{N-1} according to the output of the selection circuit 532. After determination of the logic unit 534, the output stage circuits 536₀-536_{N-1} output corresponding test patterns to perform test and measurement.

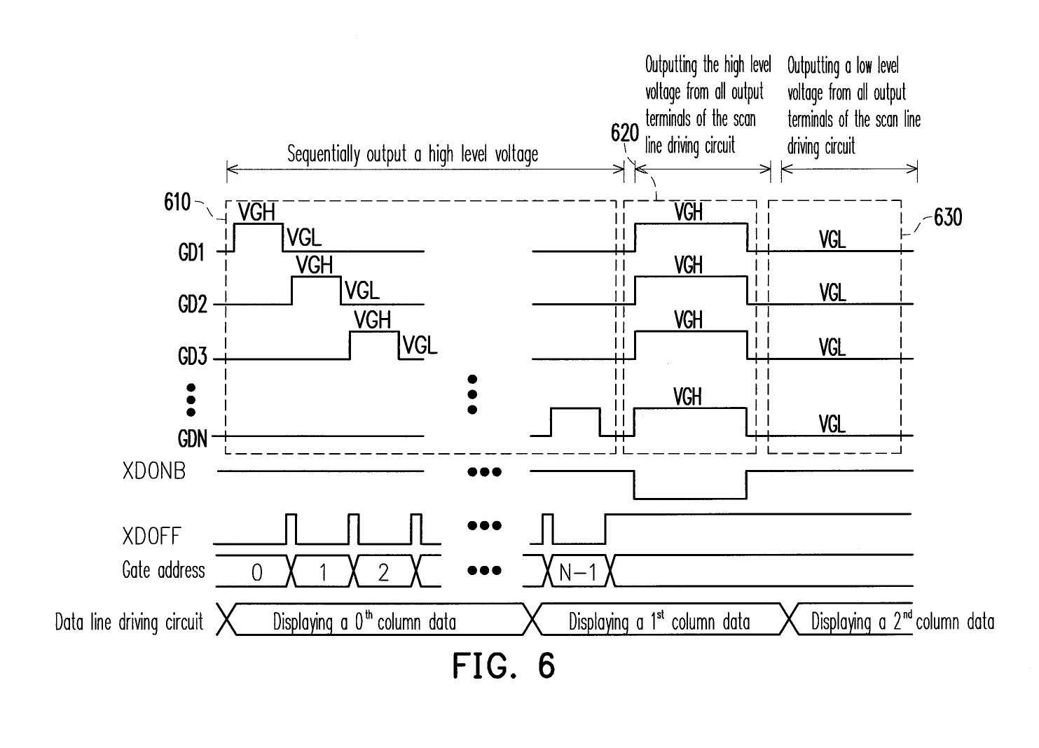

FIG. 6 is a test timing diagram of the scan line driving circuit according to an embodiment of the invention. In the embodiment, the data line driving circuit 432 receives display data sequentially output by the timing control circuit 428, and the scan line driving circuit 434 receives the test pattern (the control signal) directly transmitted from the processor 410 to quickly complete the test.

Referring to FIG. 6, the test performed on the scan line driving circuit 434 according to the test pattern includes: (1) sequentially triggering the output stage circuits 536₀-536_{N-1} in internal of the scan line driving circuit 434, i.e. the output stage circuits 536₀-536_{N-1} sequentially output the high level voltage VGH to the output terminals GD1-GDN of the scan line driving circuit 434, and the other output stage circuits output the low level voltage VGL to test the scan line driving circuit 434, as that shown by a dot line frame 610 in FIG. 6; (2) making the output stage circuits 536₀-536_{N-1} to simultaneously output the first level voltage (for example, the high level voltage VGH) to the output terminals GD1-GDN of the scan line driving circuit 434, as that shown by a dot line frame 620 of FIG. 6; and (3) making the output stage circuits 536₀-536₁₋₁ to simultaneously output the second level voltage (for example, the low level voltage VGL) to the output terminals GD1-GDN of the scan line driving circuit 434, as that shown by a dot line frame 630 of FIG. 6.

In the test operation mode of the conventional display controller driver 120, the timing control circuit 128 generates the test control signal to the scan line driving circuit 134. In order to cope with the operation of the timing control circuit 128 on the data line driving circuit 132, the fixed time of one frame has to be divided into a plurality time sections T, and the test is sequentially performed in allusion to each output terminal of the scan line driving circuit within the corresponding divided time section. The above operation of sequentially performing the test may cause delays in timing, and the test efficiency cannot be effectively improved.

In order to improve the test efficiency of the scan line driving circuit, in the structure provided by the present embodiment, the control signal required by the scan line driving circuit 434 is provided by the external test platform, so that when the scan line driving circuit 434 is tested, it is unnecessary to cope with/wait for the operation of the timing control circuit 428 on the data line driving circuit 432, so as to quickly and effectively test the scan line driving circuit 434. In an embodiment, the processor 410 can write command to the timing control circuit 428 through the system interface circuit 422 to directly test the scan line driving circuit 434 with the test pattern. In another embodiment, the processor 410 can directly transmit the test pattern to the scan line driving circuit 434 through the system interface circuit 422 to test the scan line driving circuit 434 regardless of a test operation sequence in the divided time sections predetermined by the timing control circuit 428 and regardless of an operation timing of the data line driving circuit 432, as that shown in FIG. 6. Therefore, according to the above embodiments, the test time of the display controller driver 400 can be reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display controller driver, adapted to drive a display panel, and comprising:
a timing control circuit;
an image data memory, storing display data;
a data line driving circuit, coupled to the timing control circuit, receiving the display data and outputting a grayscale voltage signal corresponding to the display data; and
a scan line driving circuit, coupled to the timing control circuit, controlled by a first control signal generated by the timing control circuit in a normal operation mode, and controlled by a second control signal generated by an external test platform in a test operation mode, wherein the second control signal serves as a test pattern for testing the display controller driver.

2. The display controller driver as claimed in claim 1, wherein the scan line driving circuit performs a test according to the test pattern, which comprises sequentially triggering a plurality of output stage circuits in internal of the scan line driving circuit; making the output stage circuits to simultaneously output a first level voltage; and making the output stage circuits to simultaneously output a second level voltage, wherein the first level is higher than the second level.

3. The display controller driver as claimed in claim 1, further comprising a grayscale voltage generating circuit for generating and providing a grayscale voltage to the data line driving circuit to generate the grayscale voltage signal.

4. The display controller driver as claimed in claim 1, wherein the second control signal comes from a processor of the external test platform.

5. The display controller driver as claimed in claim 4, wherein the processor is a processing unit of a display device, a handheld electronic device or a test device.

6. The display controller driver as claimed in claim 1, wherein the scan line driving circuit comprises:
a selection circuit, having a first input terminal, a second input terminal and an output terminal, the first input terminal receiving the first control signal generated by the timing control circuit, and the second input terminal receiving the second control signal generated by the external test platform, wherein the output terminal of the selection circuit outputs the first control signal in the normal operation mode, and the output terminal of the selection circuit outputs the second control signal in the test operation mode;
a plurality of output stage circuits, having output terminals serving as output terminals of the scan line driving circuit; and
a logic unit, coupled between the output terminal of the selection circuit and the output stage circuits, and selectively triggering the output stage circuits according to an output of the selection circuit.

7. The display controller driver as claimed in claim 6, wherein the second input terminal of the selection circuit directly receives the second control signal generated by the external test platform.

8. The display controller driver as claimed in claim 6, wherein the second input terminal of the selection circuit receives the second control signal generated by the external test platform through the timing control circuit.

9. The display controller driver as claimed in claim 1, wherein the timing control circuit selects to transmit the first control signal to the scan line driving circuit in the normal operation mode, and the timing control circuit selects to transmit the second control signal to the scan line driving circuit in the test operation mode.

10. A method for testing a display controller driver, wherein the display controller driver is adapted to drive a display panel, and the display controller driver comprises a timing control circuit, an image data memory, a data line driving circuit and a scan line driving circuit, the method for testing the display controller driver comprising:
controlling the scan line driving circuit by a control signal in a test operation mode, wherein the control signal is generated by an external test platform; and
testing and measuring the scan line driving circuit according to a test pattern of the control signal.

11. The method for testing the display controller driver as claimed in claim 10, wherein the step of testing the scan line driving circuit according to the test pattern comprises:
sequentially triggering a plurality of output stage circuits in internal of the scan line driving circuit;
making the output stage circuits to simultaneously output a first level voltage; and
making the output stage circuits to simultaneously output a second level voltage, wherein the first level is higher than the second level.

12. The method for testing the display controller driver as claimed in claim 10, wherein the control signal is transmitted to the scan line driving circuit from the external test platform through the timing control circuit.

13. The method for testing the display controller driver as claimed in claim 10, wherein the control signal is directly transmitted to the scan line driving circuit from the external test platform.
